(19) United States
(12) Patent Application Publication
(10) Pub. No.: US 2004/0260752 A1
(43) Pub. Date: Dec. 23, 2004

(54) Methods and apparatus for optimizing resource management in CDMA2000 wireless IP networks

(75) Inventors: Madhavi W. Chandra, Cary, NC (US); Kent K. Leung, Mountain View, CA (US); Parviz Yegani, Danville, CA (US)

Correspondence Address: BEYER WEAVER & THOMAS LLP, P.O. BOX 778, BERKELEY, CA, 94704-0778, US

(73) Assignee: Cisco Technology, Inc., San Jose, CA

(21) Appl. No.: 10/600,157

(22) Filed: Jun. 19, 2003

(51) Int. Cl. G06F 15/16

(52) U.S. Cl. 709/200

(57) ABSTRACT

An invention is disclosed that optimizes resource management within a PDSN. This is accomplished through the modification of functions of a AAA server. Specifically, when a node (e.g., mobile node) is authenticated by a AAA server in response to a request by a target PDSN to which the node has roamed, the AAA server may send a disconnect request message to a source PDSN indicating that the node has moved from the source PDSN. In this manner, the source PDSN is notified that it should terminate its session with the node and release resources associated with the session (e.g., PPP session). The source PDSN may then send a message to the AAA server indicating whether the session was successfully terminated (and whether the resources associated with that session were released).

### BACKGROUND OF THE INVENTION

1. Field of the Invention

The present invention relates to Mobile IP network technology. More particularly, the present invention relates to optimizing resource management at a PDSN.

2. Description of the Related Art

Mobile IP is a protocol that allows laptop computers and other mobile computer units (“mobile nodes”) to roam between various sub-networks while maintaining Internet and/or WAN connectivity. Without Mobile IP or similar protocols a mobile node would be unable to stay connected while roaming from one location serviced by one sub-network to another location being serviced by a different sub-network. This is because each IP address has a field that specifies the particular sub-network on which the node resides. If a user desires to take a computer that is normally attached to one node and roam so that it passes through different sub-networks, the roaming computer cannot use its home base IP address. As a result, a businessperson traveling across the country cannot travel with his or her computer across geographically disparate network segments or wireless nodes while maintaining Internet connectivity. This is not acceptable in the age of portable computational devices.

To address this problem, the Mobile IP protocol has been developed and implemented. An implementation of Mobile IP is described in RFC 3220, “IP Mobility Support for IPv4” of the Network Working Group, C. Perkins, Ed., January 2002. Mobile IP is also described in the text “Mobile IP, The Internet Unplugged” by J. Solomon, Prentice Hall, 1998. Both of these references are incorporated herein by reference in their entireties and for all purposes.

The Mobile IP process and environment are illustrated in FIG. 1. A Mobile IP environment 2 includes the Internet (or a WAN) 4 over which a mobile node 6 can communicate via mediation by a home agent 8 or a foreign agent 10. Typically, the home agent 8 and foreign agent 10 are routers or other network connection devices performing appropriate Mobile IP functions as implemented by software, hardware, and/or firmware. Note the overall network topology is arbitrary, and elements such as the home agent 8 need not directly connect to the Internet 4. For example, the home agent 8 may be connected through another router R1 11. Router R1 11 may, in turn, connect one or more other routers R3 13 with the Internet 4.

When mobile node 6 is plugged into its home network segment 12 it connects with the Internet 4 through its designated home agent 8. When the mobile node 6 roams, it can be connected to a remote network segment 14 and communicate through the available foreign agent 10. Other nodes, such as a PC 16, on remote network segment 14 also communicate with the Internet 4 through foreign agent 10. Presumably, there are many foreign agents available at geographically disparate locations to allow wide spread Internet connection via the Mobile IP protocol.

Mobile node 6 may identify foreign agent 10 through various agent solicitations and agent advertisements that form part of the Mobile IP protocol. When mobile node 6 engages with remote network segment 14, it composes a registration request for the home agent 8 to bind the mobile node's 6 current location with its home location. Foreign agent 10 then relays the registration request to home agent 8. During the registration process, the home agent 8 and the mobile node 6 may then negotiate the conditions of the mobile node's 6 attachment to foreign agent 10. For example, the mobile node 6 may request a registration lifetime of 5 hours, but the home agent 8 may grant only a 3 hour period. When the negotiation is successfully completed, home agent 8 updates an internal “mobility binding table” which links the mobile node's 6 current location via its care-of address (e.g., a co-located care-of address or the foreign agent's IP address) to the identity (e.g., home address) of the mobile node 6. Further, if the mobile node 6 registered via foreign agent 10, the foreign agent 10 updates an internal “visitor table” which specifies the mobile node address, home agent address, etc. The home agent's 8 association between a mobile node's home base IP address, its current care-of address, and the remaining lifetime of that association is referred to as a binding.

If mobile node 6 wanted to send a message to a correspondent node 18 from its new location, the mobile node 6 would forward a packetized output message through the foreign agent 10 over the Internet 4 to the correspondent node 18 according to standard Internet protocols. However, if the correspondent node 18 wanted to send a message to the mobile node 6—whether in reply to a message from the mobile node 6 or for any other reason—the correspondent node 18 addresses that message to the IP address of the mobile node 6 as if the mobile node 6 were on the home network segment 12. The packets of the message from the correspondent node 18 are forwarded over the Internet 4 to the router R1 11 and ultimately to the home agent 8.

From the home agent's 8 mobility binding table, the home agent 8 recognizes that the mobile node 6 is no longer attached to the home network segment 12. The home agent 8 then encapsulates the packets from correspondent node 18 (which are addressed to the mobile node 6 on the home network segment 12) according to the Mobile IP protocol, and forwards these encapsulated packets to the appropriate care-of address for mobile node 6. If the care-of address is the IP address of the foreign agent 10 the foreign agent 10 strips the encapsulation and forwards the message to the mobile node 6 on the remote network segment 14. The packet forwarding mechanism implemented by the home agent 8 to the foreign agent 10 is often referred to as “tunneling.”

FIG. 2 is a diagram illustrating a CDMA2000™ wireless IP network. As shown, a Home Agent 202 is connected to the IP network, or Internet 200. A Packet Data Serving Node (PDSN) provides access to the Internet, intranets and applications servers for mobile nodes utilizing a CDMA2000™ Radio Access Network (RAN), and operates in accordance with the cdma2000 Wireless IP Network Standard, TIA/ELIAS-835-B, September 2002, which is incorporated herein by reference for all purposes. Acting as an access gateway, the PDSN provides simple IP and mobile IP access, foreign agent support, and packet transport for virtual private networking. It also acts as a client for Authentication, Authorization, and Accounting (AAA) servers and provides mobile nodes with a gateway to the IP network. Each PDSN supports layer 3 mobility using Mobile IP protocol and is primarily responsible for the following functions:

Establish, maintain, and terminate PPP session to the mobile node

Assign/provide IP address for Simple IP (the dynamic address may be chosen by the PDSN or AAA)

Support Foreign Agent functionality

Initiate authentication, authorization, and accounting to the AAA for the mobile node

For Simple IP, map the mobile node IP address with a unique layer connection used to communicate with the PCF. For Mobile IP, map the mobile node IP and HA addresses with a unique link layer identifier used to communicate with the PCF

For Mobile IP, optionally, interact with a previous PDSN to support handoffs between PDSNs (including fast handoff)

Route packets to IP networks or directly to the HA in the case of reverse tunneling

Interact with the PCF to establish, maintain and terminate the layer 2 connection between PCF and PDSN

Mark and process packets as necessary according to the QoS profile

Optionally send Agent Advertisement(s) if the PCF indicates the mobile node has undergone a dormant handoff

AAA servers are capable of storing security-associations for multiple Home Agents, as well as provide further services. By way of example, the centralized server may provide authentication services and/or authorization services. While authentication determines who an entity is, authorization determines what services a user is allowed to perform, or access. Various protocols such as the Remote Authentication Dial In User Service (RADIUS) and TACACS+ may be implemented to provide such a server. In addition, this protocol may similarly be implemented on each Home Agent that communicates with the server. RFC 2865 describes the RADIUS Protocol and is hereby incorporated by reference. Similarly, RFC 1492 describes TACACS and the Internet-Draft “The TACACS+ Protocol Version 1.78,” available at http://www.ietf.org/internet-drafts/draft-grant-tacacs-02.txt, describes TACACS+. Both of these documents are incorporated herein by reference for all purposes.

In this example, two different PDSNs, 204 and 206 are connected to the Internet 200. A Packet Control Function (PCF) is an entity in a radio access network that provides a layer 2 signaling connection and one or more bearer connections between the Base Station (BS) and the PDSN. In this example, two different PCFs 208 and 210 control transmission of user traffic between corresponding base stations 212 and 214, respectively, and the PDSNs 204 and 206, respectively. Each PCF supports layer 2 mobility and is primarily responsible for the following functions:

Establish maintain and terminate layer 2 connection to the PDSN

Interact with the PDSN to support dormant handoff

Maintain knowledge of radio resource status (e.g. active, dormant)

Buffer packets arriving from the PDSN when radio resources are not in place or are insufficient to support the flow from the PDSN

Communicate with the base station to request and manage radio resources in order to relay packets to/from the mobile node and the PDSN

Collect and send airlink related accounting information to the PDSN

The Wireless IP Network Standard as defined in IS-835 [1] defines PDSN procedures for managing a Point-to-Point Protocol (PPP) session for a mobile node. For instance, when the Radio Network sends a request to the PDSN to set up a new R-P connection, the PDSN initiates establishment of a PPP session. When a Mobile Node 216 establishes a PPP session 220 with the PDSN 204, the PDSN 204 stores PPP state information. The PPP state information is defined in RFC 1661, “The Point-to-Point protocol (PPP),” Simpson et al, July 1994, which is incorporated herein by reference for all purposes. For instance, the PPP state information may include a PPP session timer, LCP/IPCP state, etc.

As the mobile node moves from one foreign domain serviced by a PDSN (source PDSN), shown here as PDSN 204, to another PDSN (target PDSN), shown here as PDSN 206, during an inter-PDSN hand-off, a new PPP session is established at the target PDSN. Specifically, when the node moves or the Mobile Node 216 roams such that the PDSN 206 initiates a second PPP session, PPP state information is stored at the target PDSN 206. Thus, the first PDSN 204 no longer needs to store the PPP state information. Unfortunately, the first PDSN 204 does not release its PPP resources until the PPP session timer has expired. Since the timer may be set to a long value, for example it may expire as much as several hours after the node or mobile node has moved to another PDSN, the PPP state information may be unnecessarily stored by the first PDSN 204 during this time. Maintaining these PPP sessions and associated resources may consume valuable resources at the source PDSN that could otherwise be used to support additional mobile nodes. Since the resources available at the PDSN 204 are limited, this reduces the number of sessions the PDSN 204 can handle.

In view of the above, it would be desirable if a mechanism were available to increase the number of sessions a PDSN can support through optimizing resource management at the PDSN.

### SUMMARY OF THE INVENTION

An invention is disclosed that optimizes resource management within a PDSN. This is accomplished through the modification of functions of a AAA server. When the PDSN receives a disconnect request from the AAA server, it may then disconnect a session and release associated resources.

In accordance with one aspect of the invention, a target PDSN to which a node (e.g., mobile node) has roamed sends an access request message to a AAA server. When the node (e.g., mobile node) is authenticated by a AAA server, the AAA server may then send a disconnect request message to a source PDSN indicating that the node has moved from the source PDSN. In this manner, the source PDSN is notified that it should disconnect a specified session with the node and release resources associated with the specified session (e.g., PPP session). The source PDSN may then send a message to the AAA server indicating whether the session was successfully disconnected (and whether the resources associated with that session were released).

In accordance with another aspect of the invention, a visited AAA server in the foreign network and a home AAA server in the home network function together to authenticate the node (e.g., mobile node). The home AAA server may initiate a disconnect request in response to the receipt of an access request from the target PDSN. Alternatively, the visited AAA server may initiate a disconnect request in response to an access accept message received from the home AAA server sent in response to an access request message previously sent by the target PDSN.

Various network devices may be configured or adapted for intercepting, generating, modifying, and transmitting packets, messages and data structures to implement the disclosed methods. These network devices include, but are not limited to, servers (e.g., hosts) and routers. Moreover, the functionality for the disclosed processes may be implemented in software as well as hardware.

Yet another aspect of the invention pertains to computer program products including machine-readable media on which are provided program instructions for implementing the methods and techniques described above, in whole or in part. Any of the methods of this invention may be represented, in whole or in part, as program instructions that can be provided on such machine-readable media. In addition, the invention pertains to various combinations and arrangements of data generated and/or used as described herein. For example, packets and data structures having the format described herein and provided on appropriate media are part of this invention.

These and other features of the present invention will be described in more detail below in the detailed description of the invention and in conjunction with the following figures.

### BRIEF DESCRIPTION OF THE DRAWINGS

FIG. 1 is a block diagram of a Mobile IP environment.

FIG. 2 is a diagram illustrating a CDMA2000™ wireless IP network.

FIG. 3 is a transaction flow diagram illustrating a first method of optimizing resource management in a wireless IP network such as that illustrated in FIG. 2 in accordance with various embodiments of the invention.

FIG. 4 is a transaction flow diagram illustrating a second method of optimizing resource management in a wireless IP network such as that illustrated in FIG. 2 in accordance with various embodiments of the invention.

FIG. 5 is a diagram illustrating an exemplary disconnect request message transmitted by a AAA server in accordance with various embodiments of the invention.

FIG. 6 is a diagram illustrating an exemplary disconnect acknowledgement message transmitted by a PDSN in accordance with various embodiments of the invention.

FIG. 7 is a diagram illustrating an exemplary disconnect NAK message transmitted by a PDSN in accordance with various embodiments of the invention.

FIG. 8 is a diagram illustrating an exemplary network device in which various embodiments of the invention may be implemented.

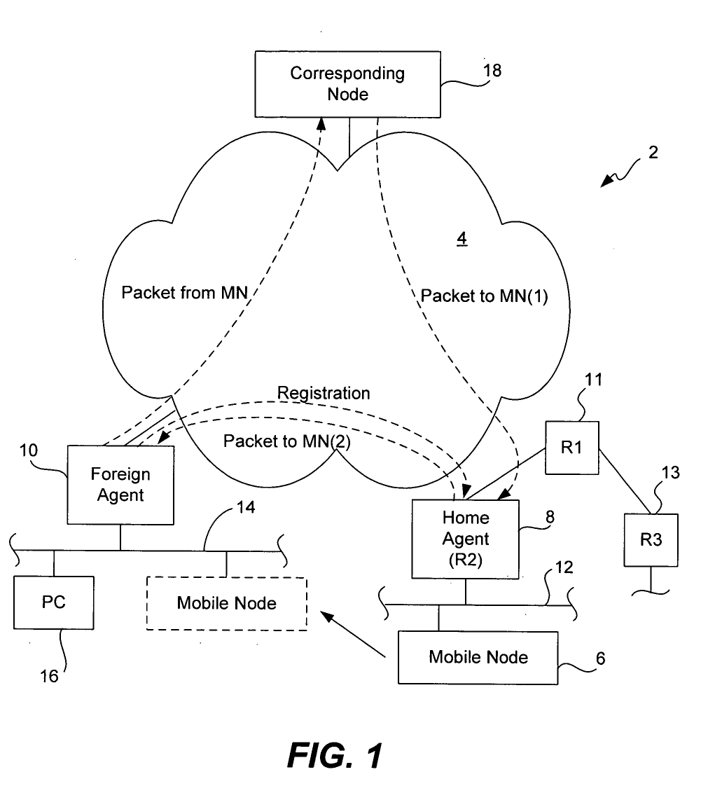

### DETAILED DESCRIPTION OF THE PREFERRED EMBODIMENTS

In the following description, numerous specific details are set forth to provide a thorough understanding of the present invention. It will be obvious, however, to one skilled in the art that the present invention may be practiced without some or all of these specific details. In other instances, well known process steps have not been described in detail in order to avoid unnecessarily obscuring the present invention.

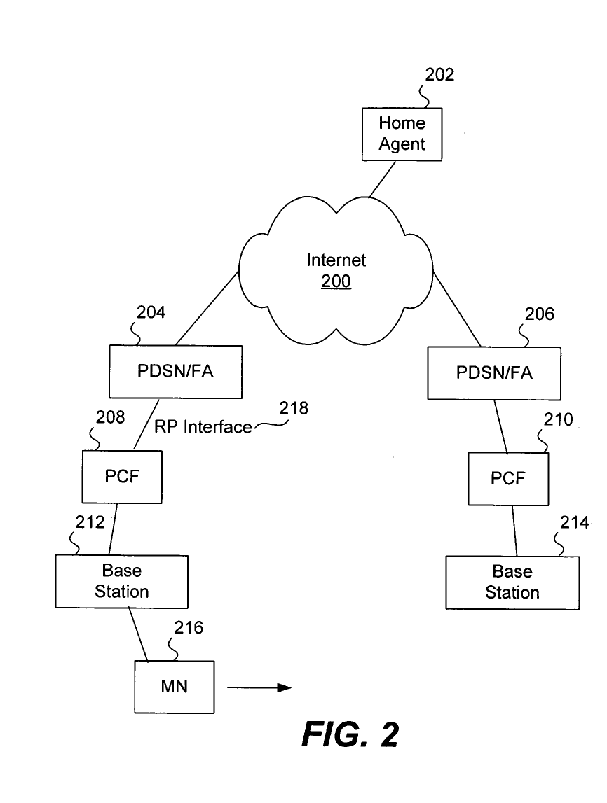

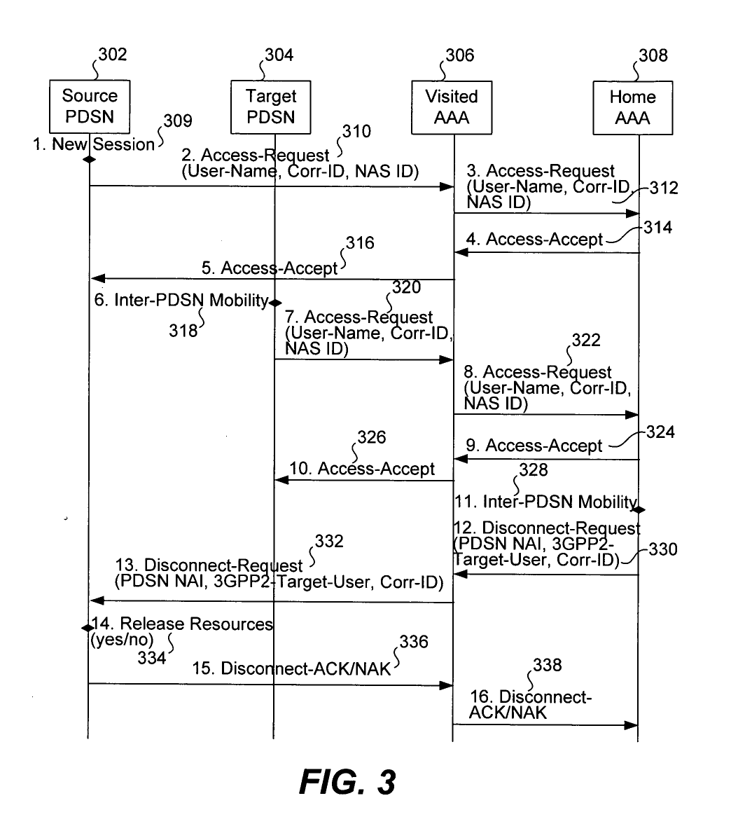

FIG. 3 is a transaction flow diagram illustrating a first method of optimizing resource management in a wireless IP network such as that illustrated in FIG. 2 in accordance with various embodiments of the invention. Process steps performed by the source PDSN, target PDSN, a first AAA server (e.g., visited AAA server), and a second AAA server (e.g., home AAA server) are described with reference to vertical lines 302, 304, 306, and 308, respectively. As described with reference to Attorney Docket No. CISCP076, entitled “MOBILE IP AUTHENTICATION,” patent application Ser. No. 09/227,399, filed on Jan. 8, 1999, by inventor Kent K. Leung, which is incorporated herein by reference, a AAA server may be used to authenticate a mobile node. The visited AAA server is a AAA server located in a foreign network, while the home AAA server is a AAA server located in the home network. In the embodiment illustrated in FIG. 3, the two different AAA servers are used to notify the source PDSN that resources such as those used to store PPP state and other associated information are no longer needed. However, it is important to note that a single AAA server (e.g., home AAA server) may also be used.

As shown, the source PDSN 302 establishes a new PPP session at 309 with the mobile node. When the mobile node establishes the PPP session, it submits its username or Network Access Indentifier (NAI) in the PPP control messages during PAP or CHAP authentication negotiation. For instance, the username may be joe@cisco.com In this manner, the source PDSN obtains the username of the mobile node. If the mobile node does not negotiate CHAP or PAP, then no NAI is received by the PDSN. In this case, the PDSN may construct a properly formatted NAI based on the mobile node identifier as provided in RFC 2486, which is incorporated herein by reference for all purposes.

The first source PDSN sends an access request message such as a RADIUS access request message to a first AAA server for authentication of the node at 310. The first AAA server may, for example, be a visited AAA server 306. The RADIUS access request message includes the username identifier (e.g., joe@cisco.com) that identifies a user associated with the PPP session (and Mobile IP session), a session identifier identifying a session associated with the user, session termination capability, and a PDSN identifier identifying the source PDSN (e.g., PDSN01.carrier.com). The session identifier or “correlation ID” is a unique number that is assigned by the PDSN to a particular session. The first AAA server 306 then forwards the access request message to the second AAA server, which is preferably a home AAA server located in the home network at 312.

Once the home AAA server 308 authenticates the mobile node, it sends an access accept packet such as a RADIUS access accept packet at 314 to the visited AAA server 306. Specifically, the access accept packet includes the username identifier identifying the user, the session identifier identifying the session to be disconnected, and the PDSN identifier identifying the source PDSN. The visited AAA server 306 then forwards the access accept message to the source PDSN at 316. The access accept message includes the username identifier identifying the user, the session identifier identifying a session associated with the user, and the PDSN identifier identifying the first PDSN.

When the source PDSN 302 receives the access accept message, it establishes a Mobile IP session as a Foreign Agent for the mobile node. During this time, the source PDSN 302 stores information associated with the node in resources associated with the PDSN. For instance, the resources may comprise memory and the information may be, for example, PPP information associated with a PPP session and/or information associated with the Mobile IP session.

When the mobile node roams to the target PDSN 304, this inter-PDSN mobility is represented at 318. At this time, layer 3 mobility continues to be supported at the source PDSN 302. The target PDSN 304 then sends an access request message including the username identifier identifying the user, the session identifier identifying the session associated with the user, and the PDSN identifier identifying the source PDSN at 320. When the first, visited AAA server 306 receives the access request message from the target PDSN, it forwards the access request message to the home AAA server at 322. The home AAA server then sends an access accept message to the visited AAA server in response to the access request message at 324, which is then forwarded to the target PDSN at 326. As described above, the access accept packet includes the username identifier identifying the user, the session identifier identifying the session associated with the user, and the PDSN identifier identifying the source PDSN.

Once the second access accept packet is sent by the home AAA server at 324, inter-PDSN mobility is established at 328. The second home AAA server then sends a disconnect request message to the first source PDSN indicating a request for the release of resources associated with the session. In this example, the disconnect request is first sent to the first visited AAA server at 330, which is then forwarded to the source PDSN at 332.

The disconnect request message indicates that the resources associated with the specified session are no longer needed. In other words, the disconnect request message may indicate that a node (e.g., mobile node) associated with the user has moved. In accordance with one embodiment, the disconnect request message includes a source PDSN identifier identifying the source PDSN, a username identifier identifying the user, and a session identifier identifying a session (e.g., PPP session) associated with the user to be terminated by the first PDSN. Thus, the disconnect request message may request that the first source PDSN release the resources associated with the session identified by the session identifier. Note that resources associated with all other sessions for the same user may not be released.

In this example, the disconnect request message is triggered by the second access request message sent to the home AAA server by the target PDSN to which the node has roamed. Specifically, the disconnect request message is sent after an access accept message is sent by the home AAA server in response to the second access request message.

When the source PDSN receives the disconnect request message sent by the home AAA server, it releases all the resources associated with the session for which a disconnect message is received at 334. The source PDSN then sends a disconnect acknowledgement message or non-acknowledgement message. The ACK or NAK message may be sent to the visited AAA server or to the home AAA server. In this example, the ACK or NAK message is addressed to the home AAA server. When the ACK or NAK message is received by the visited AAA server at 336, it is forwarded to the home AAA server at 338. The disconnect acknowledgement message may indicate that the source PDSN has successfully terminated the session (and released the resources), while the non-acknowledgement message may indicate that the source PDSN is unable to terminate the session (and therefore unable to release the resources).

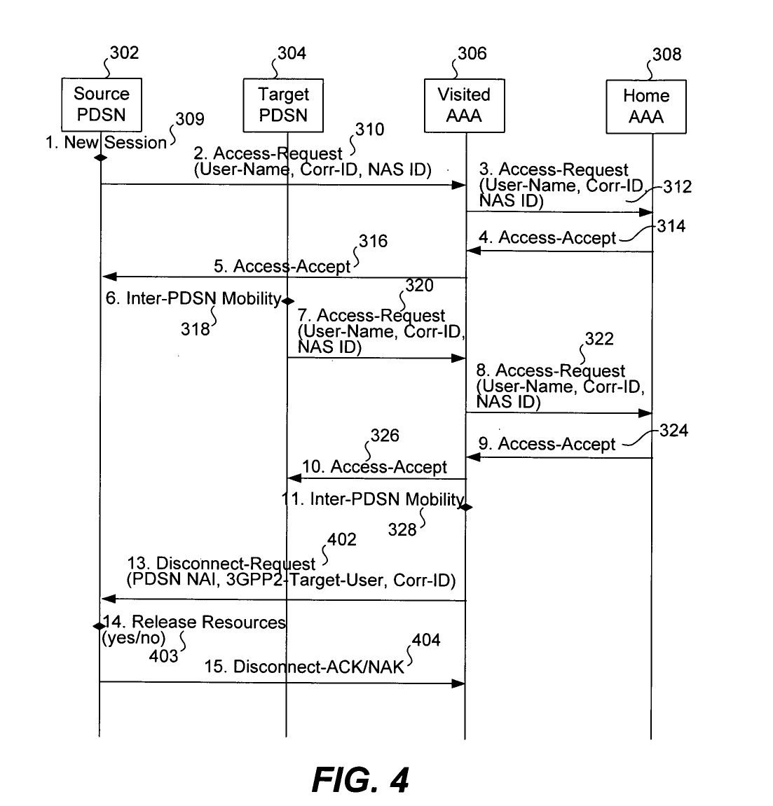

FIG. 4 is a transaction flow diagram illustrating a second method of optimizing resource management in a wireless IP network such as that illustrated in FIG. 2 in accordance with various embodiments of the invention. In the second embodiment, the present invention is optimized to reduce the transmission of messages between the visited AAA server 306 and the home AAA server 308. Specifically, when the access accept message sent from the home AAA server 308 is received at the visited AAA server at 324, the visited AAA server 306 sends a disconnect request to the source PDSN at 402. As described above, the access accept message preferably includes the username identifier identifying the user, the session identifier identifies the session associated with the user, and the PDSN identifier identifies the source PDSN. It is important to note that the access accept message preferably includes the PDSN identifier identifying the source PDSN, since the visited AAA server may not be the same as the previous visited AAA server, and therefore may not be aware of the identity of the source PDSN. In addition, the disconnect request message indicates a request to release resources associated with the session, as described above with reference to FIG. 3.

When the source PDSN receives the disconnect request, it terminates the session and releases resources associated with the session, if possible, at 403. The source PDSN then sends a disconnect acknowledgement or non-acknowledgement message at 404 to the visited AAA server. In this manner, the visited AAA server (or home AAA server as described above with reference to FIG. 3) may ascertain whether the resources were released. For instance, if the resources have not been released, the visited or home AAA server may choose to send another disconnect request message upon receipt of a non-acknowledgement message. In this manner, resource management is performed in the Foreign domain.

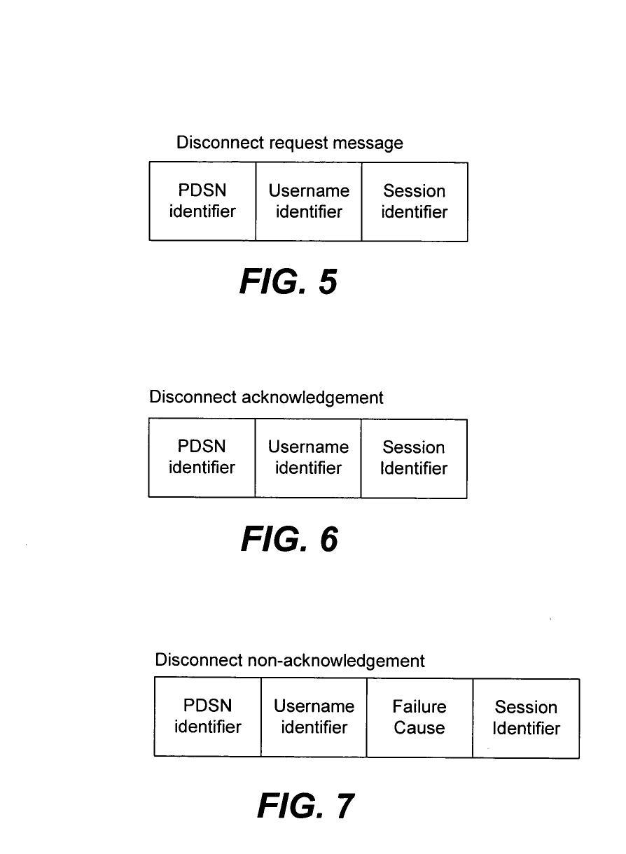

FIG. 5 is a diagram illustrating an exemplary disconnect request message transmitted by a AAA server in accordance with various embodiments of the invention. As shown in FIG. 5, the disconnect request message includes a source PDSN identifier identifying the source PDSN, a username identifier identifying a user associated with the Mobile IP session, and a session identifier identifying a session associated with the user to be terminated by the source PDSN.

FIG. 6 is a diagram illustrating an exemplary disconnect acknowledgement message transmitted by a PDSN in accordance with various embodiments of the invention. A disconnect acknowledgement message includes both the usemname and the session identifier, thereby enabling the AAA server to ascertain which session has been disconnected. FIG. 7 is a diagram illustrating an exemplary disconnect NAK message transmitted by a PDSN in accordance with various embodiments of the invention. A disconnect non-acknowledgement message includes a failure cause, as well as the usemname and the session identifier, thereby enabling the AAA server to ascertain which session could not be disconnected. In this manner, the AAA server may ascertain whether resources have been released. Formats of the above-described messages may be implemented in RADIUS or TACACS+. RADIUS disconnect request, ACK, and NAK messages are described in further detail in Chiba et al, http://www.draft-chiba-radius-dynamic-authorization-05.txt, “Dynamic Authorization Extensions to Remote Authentication Dial-In User Service (RADIUS)”, August 2002.

In the above-described embodiments, the AAA servers may be RADIUS servers, as well as TACACS+ or other AAA servers. Moreover, the above-described messages are merely illustrative, and therefore other message formats may be used to communicate among the PDSNs and AAA servers.

Generally, the techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the techniques of this invention may be implemented on a general-purpose programmable machine selectively activated or reconfigured by a computer program stored in memory. Such a programmable machine may be a network device designed to handle network traffic, such as, for example, a router or a switch. Such network devices may have multiple network interfaces including frame relay and ISDN interfaces, for example. Specific examples of such network devices include routers and switches. For example, home agents, and foreign agents of this invention may be implemented in specially configured routers, switches or servers, such as specially configured router models 2600, 3200, 3600, 4500, 7200, and 7500 available from Cisco Systems, Inc. of San Jose, Calif. A general architecture for some of these machines will appear from the description given below. In an alternative embodiment, the techniques of this invention may be implemented on a general-purpose network host machine such as a personal computer or workstation. Further, the invention may be at least partially implemented on a card (e.g., an interface card) for a network device or a general-purpose computing device.

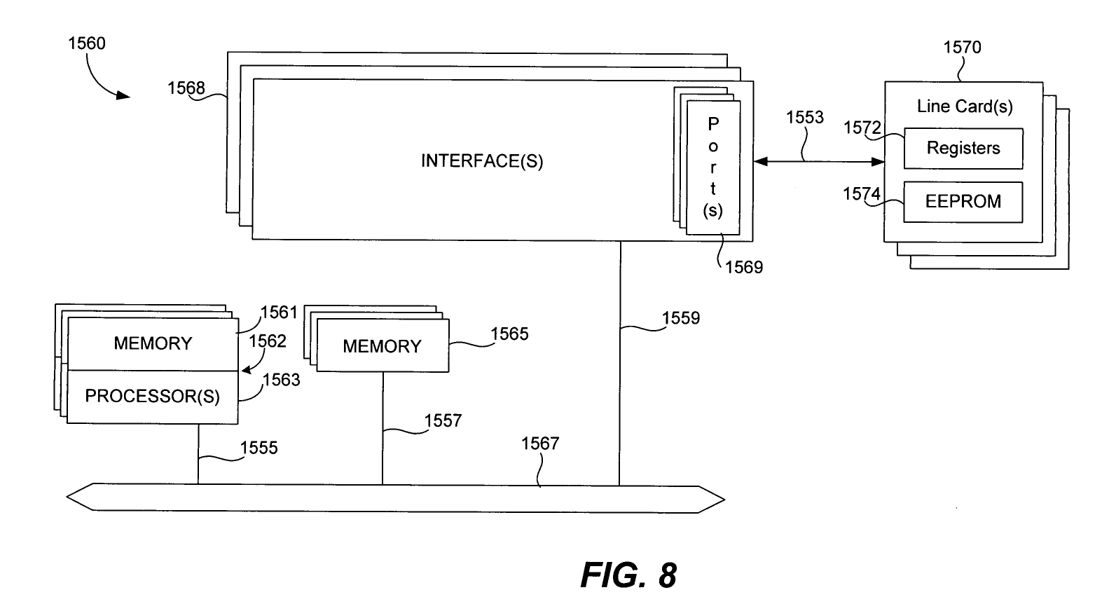

Referring now to FIG. 8, a network device 1500 suitable for implementing the techniques of the present invention includes a master central processing unit (CPU) 1505, interfaces 1510, memory 1515 and a bus 1520. When acting under the control of appropriate software or firmware, the CPU 1505 may be responsible for implementing specific functions associated with the functions of a desired network device. For example, when configured as an intermediate router, the CPU 1505 may be responsible for analyzing packets, encapsulating packets, and forwarding packets for transmission to a set-top box. The CPU 1505 preferably accomplishes all these functions under the control of software including an operating system (e.g. Windows NT), and any appropriate applications software.

CPU 1505 may include one or more processors such as those from the Motorola family of microprocessors or the MIPS family of microprocessors. In an alternative embodiment, the processor is specially designed hardware for controlling the operations of network device 1500.

The interfaces 1510 are typically provided as interface cards (sometimes referred to as “line cards”). Generally, they control the sending and receiving of data packets over the network and sometimes support other peripherals used with the network device 1500. Among the interfaces that maybe provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces, ASI interfaces, DHEI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the CPU 1505 to efficiently perform routing computations, network diagnostics, security functions, etc.

Although the system shown in FIG. 8 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, the memory 1515) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is described as being configured to comply with Mobile IP standards in force as of the time this document was written. However, it should be understood that the invention is not limited to such implementations. Accordingly, the present embodiments are to be considered as illustrative and not restrictive, and the invention is not to be limited to the details given herein, but may be modified within the scope and equivalents of the appended claims.

What is claimed is:

1. In a PDSN, a method of releasing resources, comprising:
sending an access request message to a first AAA server for authentication of a node;
receiving an access accept message from the first AAA server;
establishing a Mobile IP session as a Foreign Agent for the node when an access accept message is received from the first AAA server;
storing information associated with the node in resources associated with the PDSN;
receiving a disconnect request message; and
releasing the resources when the disconnect request message is received.

2. The method as recited in claim 1, wherein the disconnect request message is received from the first AAA server.

3. The method as recited in claim 1, wherein the disconnect request message is received from a second AAA server via the first AAA server.

4. The method as recited in claim 1, wherein the resources comprise memory and the information comprises PPP information associated with a PPP session.

5. The method as recited in claim 1, wherein the resources comprise memory and the information is associated with the Mobile IP session.

6. The method as recited in claim 3, wherein the first AAA server is the second AAA server.

7. The method as recited in claim 3, wherein the first AAA server is a visited AAA server associated with a foreign network and the second AAA server is a home AAA server associated with a home network of the node.

8. The method as recited in claim 3, wherein the first AAA server is a visited AAA server associated with a foreign network and the second AAA server is the visited AAA server associated with the foreign network.

9. The method as recited in claim 3, wherein the access request message and access reply message are RADIUS messages, and the first and second AAA servers are RADIUS servers.

10. The method as recited in claim 1, wherein the disconnect request message comprises a source PDSN identifier identifying the PDSN, a username identifier identifying a user associated with the Mobile IP session, and a session identifier identifying a session associated with the user to be terminated by the PDSN.

11. The method as recited in claim 10, wherein the session is a PPP session.

12. The method as recited in claim 3, wherein the disconnect request message is triggered by a second access request message sent to the second AAA server by a second PDSN to which the node has roamed.

13. The method as recited in claim 12, wherein the disconnect request message is sent after an access accept message is sent by the second AAA server to the first AAA server.

14. The method as recited in claim 12, wherein the access request message and the second access request message each comprise a RADIUS access request message including a username identifier identifying a user associated with the Mobile IP session, a session identifier identifying a session associated with the user, and a PDSN identifier identifying the PDSN.

15. The method as recited in claim 1, further comprising:
sending a disconnect acknowledgement message indicating that the PDSN has successfully disconnected the user.

16. The method as recited in claim 15, wherein the disconnect acknowledgement message is sent to the first AAA server.

17. The method as recited in claim 3, further comprising:
sending a disconnect acknowledgement message to the second AAA server, the disconnect acknowledgement message indicating that the PDSN has successfully disconnected the user.

18. The method as recited in claim 1, further comprising:
sending a disconnect non-acknowledgement message indicating that the PDSN is unable to disconnect the user.

19. The method as recited in claim 18, wherein the disconnect non-acknowledgement message is sent to the first AAA server.

20. The method as recited in claim 3, further comprising:
sending a disconnect non-acknowledgement message to the second AAA server, the disconnect non-acknowledgement message indicating that the PDSN is unable to disconnect the user.

21. In a AAA server, a method of initiating the release of resources in a first PDSN, comprising:
receiving an access request message from a second PDSN, the access request message including a username identifier identifying a user, a session identifier identifying a session associated with the user, and a PDSN identifier identifying the first PDSN;
sending an access accept message to the second PDSN in response to the access request message; and
sending a disconnect request message to the first PDSN indicating a request to release resources associated with the session.

22. The method as recited in claim 21, wherein the disconnect request message further indicates that the resources associated with the session are no longer needed.

23. The method as recited in claim 21, wherein the disconnect request message further indicates that a node associated with the user has moved.

24. The method as recited in claim 23, wherein the node is a mobile node.

25. The method as recited in claim 21, wherein the disconnect request message requests that the first PDSN disconnect the user for the session identified by the session identifier.

26. The method as recited in claim 21, wherein the AAA server is a home AAA server associated with a home network of the user.

27. The method as recited in claim 21, wherein the disconnect request message comprises a source PDSN identifier identifying the first PDSN, a username identifier identifying a user associated with the Mobile IP session, and a session identifier identifying a session associated with the user to be terminated by the first PDSN.

28. The method as recited in claim 27, wherein the session is a PPP session.

29. The method as recited in claim 27, further comprising:
receiving a disconnect acknowledgement message from the first PDSN indicating that the first PDSN has successfully disconnected the user.

30. The method as recited in claim 27, further comprising:
receiving a disconnect non-acknowledgement message from the first PDSN indicating that the first PDSN is unable to disconnect the user.

31. In a first AAA server, a method of initiating the release of resources in a first PDSN, comprising:
receiving an access accept message from a second AAA server, the access accept message including a usemname identifier identifying a user, a session identifier identifying a session associated with the user, and a PDSN identifier identifying the first PDSN; and
sending a disconnect request message to the PDSN identifier identifying the first PDSN, the disconnect request message indicating a request to release resources associated with the session.

32. The method as recited in claim 31, wherein the disconnect request message further indicates that the resources associated with the session are no longer needed.

33. The method as recited in claim 31, wherein the disconnect request message further indicates that a node associated with the user has moved.

34. The method as recited in claim 33, wherein the node is a mobile node.

35. The method as recited in claim 31, wherein the disconnect request message requests that the first PDSN disconnect the user for the session identified by the session identifier.

36. The method as recited in claim 31, wherein the second AAA server is a home AAA server associated with a home network of the user, and the first AAA server is a visited AAA server associated with a foreign network.

37. The method as recited in claim 31, wherein the disconnect request message comprises a source PDSN identifier identifying the first PDSN, a username identifier identifying a user associated with the Mobile IP session, and a session identifier identifying a session associated with the user to be terminated by the first PDSN.

38. The method as recited in claim 37, wherein the session is a PPP session.

39. The method as recited in claim 37, further comprising:
receiving a disconnect acknowledgement message from the first PDSN indicating that the first PDSN has successfully disconnected the user.

40. The method as recited in claim 37, further comprising:
receiving a disconnect non-acknowledgement message from the first PDSN indicating that the first PDSN is unable to disconnect the user.

41. The method as recited in claim 31, wherein the disconnect request message is sent when the access accept message is received by the first AAA server.

42. A computer-readable medium storing thereon computer-readable instructions for releasing resources in a PDSN, comprising:
computer-readable instructions for sending an access request message to a first AAA server for authentication of a node;
computer-readable instructions for receiving an access accept message from the first AAA server;
computer-readable instructions for establishing a Mobile IP session as a Foreign Agent for the node when an access accept message is received from the first AAA server;
computer-readable instructions for storing information associated with the node in resources associated with the PDSN;
computer-readable instructions for receiving a disconnect request message; and
computer-readable instructions for releasing the resources when the disconnect request message is received.

43. A PDSN adapted for releasing resources, comprising:
means for sending an access request message to a first AAA server for authentication of a node;
means for receiving an access accept message from the first AAA server;
means for establishing a Mobile IP session as a Foreign Agent for the node when an access accept message is received from the first AAA server;
means for storing information associated with the node in resources associated with the PDSN;
means for receiving a disconnect request message; and
means for releasing the resources when the disconnect request message is received.

44. A PDSN adapted for releasing resources, comprising:
a processor; and
a memory, at least one of the processor and the memory being adapted for:
sending an access request message to a first AAA server for authentication of a node;
receiving an access accept message from the first AAA server;
establishing a Mobile IP session as a Foreign Agent for the node when an access accept message is received from the first AAA server;
storing information associated with the node in resources associated with the PDSN;
receiving a disconnect request message; and
releasing the resources when the disconnect request message is received.

45. A computer-readable medium storing thereon computer-readable instructions for initiating the release of resources in a first PDSN at a AAA server, comprising:
instructions for receiving an access request message from a second PDSN, the access request message including a username identifier identifying a user, a session identifier identifying a session associated with the user, and a PDSN identifier identifying the first PDSN;
instructions for sending an access accept message to the second PDSN in response to the access request message; and
instructions for sending a disconnect request message to the first PDSN indicating a request to release resources associated with the session.

46. A AAA server adapted for initiating the release of resources in a first PDSN, comprising:
a processor; and
a memory, at least one of the processor and the memory being adapted for:
receiving an access request message from a second PDSN, the access request message including a username identifier identifying a user, a session identifier identifying a session associated with the user, and a PDSN identifier identifying the first PDSN;
sending an access accept message to the second PDSN in response to the access request message; and
sending a disconnect request message to the first PDSN indicating a request to release resources associated with the session.

47. A computer-readable medium storing thereon computer-readable instructions for initiating the release of resources in a first PDSN at a AAA server, comprising:
instructions for receiving an access accept message from a second AAA server, the access accept message including a username identifier identifying a user, a session identifier identifying a session associated with the user, and a PDSN identifier identifying the first PDSN; and
instructions for sending a disconnect request message to the PDSN identifier identifying the first PDSN, the disconnect request message indicating a request to release resources associated with the session.

48. A AAA server adapted for initiating the release of resources in a first PDSN, comprising:
a processor; and
a memory, at least one of the processor and the memory being adapted for:
receiving an access accept message from a second AAA server, the access accept message including a username identifier identifying a user, a session identifier identifying a session associated with the user, and a PDSN identifier identifying the first PDSN; and
sending a disconnect request message to the PDSN identifier identifying the first PDSN, the disconnect request message indicating a request to release resources associated with the session.
